(19) United States
(12) Patent Application Publication
(10) Pub. No.: US 2020/0311669 A1
(43) Pub. Date: Oct. 1, 2020

(54) METHOD AND APPARATUS FOR DELIVERY OPTIMIZATION

(71) Applicant: Wal-Mart Apollo, LLC, Bentonville, AR (US)

(72) Inventors: Pratosh Deepak RAJKHOWA, Sunnyvale, CA (US); Shekhar GUPTA, Bangalore (IN); Pavan Kumar RAICHUR RAJOLI, Bangalore (IN)

(21) Appl. No.: 16/370,515

(22) Filed: Mar. 29, 2019

(51) Int. Cl. G06Q 10/08; G06Q 50/30

(52) U.S. Cl. CPC G06Q 10/0833; G06Q 50/30; G06Q 10/087; G06Q 10/0832

(57) ABSTRACT

This application relates to apparatus and methods for assigning containers to storage racks of a delivery vehicle. In some examples, a computing device may assign a first number of a plurality of containers to a first section of a storage rack of the delivery vehicle. Based on determining that the first section of the storage rack cannot store the at least one additional container, the computing device may assign a second number of the plurality of containers to a second section of the storage rack. The computing device may also assign additional containers of the plurality of containers to other sections of the storage rack. The computing device may transmit data identifying the container assignments to a mobile device, such as one operated by an associate. The associate may proceed to store the containers in the storage rack of the delivery vehicle according to the received data.

### TECHNICAL FIELD

The disclosure relates generally to delivery services and, more specifically, to delivery management systems.

### BACKGROUND

At least some retailers deliver purchased goods to a customer. When an order is placed, the retailers must gather the purchased goods and place them on a vehicle, such as a truck, for delivery. When a purchase order is received, the retailers may have associates that collect the goods for the purchase order from various areas of a warehouse or store. As the associates gather the purchased goods, they may place them into containers, such as totes. The containers may be stacked on a moving platform, such as a dolly, and may be taken to a part of the warehouse or store where the purchased goods may be placed into a delivery truck. Loading the delivery truck with the purchased goods takes time, depending on the number and size of the orders and the number of personnel loading the vehicle with purchased goods. For example, containers holding the purchased goods may be loaded in order of a sequence number. However, a container with the next sequence number may be on a different container and have several other containers placed on top of it, which would have to be moved first and then re-stacked afterwards.

Typically, a delivery vehicle will hold purchased goods for more than one order to be delivered to multiple delivery addresses. The driver or delivery personnel making the delivery needs to know where the goods for each order are located in the vehicle, so that the proper goods delivered to each delivery address. When arriving at each delivery address, the driver or delivery personnel must first identify where the good for the corresponding delivery order are located in the vehicle, and then must proceed with unloading the goods from the vehicle, all of which take time. Retailers may benefit from reducing the amount of time it takes to load a delivery vehicle, identify goods associated with a purchase order, and unload the purchased goods from the delivery vehicle.

### SUMMARY

The embodiments described herein are directed to improving and/or optimizing delivery services by, for example, reducing the amount of time it takes to load or unload a delivery vehicle with items. As a result, a retailer employing one or more of the embodiments may be benefit with less effort and time required for these and other activities, thereby allowing delivery personnel to become more efficient, improving customer service, and reducing delivery costs.

In some embodiments, a computing device is configured to obtain data identifying a plurality of containers to hold items for an order. The computing device is also configured to assign a first number of the plurality of containers to a first section of a storage rack of a delivery vehicle, and determine whether the first section of the storage rack of the delivery vehicle can store at least one additional container. Based on determining that the first section of the storage rack cannot store the at least one additional container, the computing device may be configured to assign a second number of the plurality of containers to a second section of the storage rack of the delivery vehicle. The computing device may further be configured to assign a third number of the plurality of containers to a third section of the storage rack of the delivery vehicle, and store data identifying the assignments of the first number, second number, and third number of the plurality of containers. In some examples, the computing device may be configured to transmit the assignments to another computing device.

In some embodiments, a method is provided that includes obtaining data identifying a plurality of containers to hold items for an order. The method may further include assigning a first number of the plurality of containers to a first section of a storage rack of a delivery vehicle, and determining whether the first section of the storage rack of the delivery vehicle can store at least one additional container. The method may also include assigning a second number of the plurality of containers to a second section of the storage rack of the delivery vehicle based on determining that the first section of the storage rack cannot store the at least one additional container. The method may include assigning a third number of the plurality of containers to a third section of the storage rack of the delivery vehicle, and storing data identifying the assignments of the first number, second number, and third number of the plurality of containers. In some examples, the method may include transmitting the assignments to another computing device.

In yet other embodiments, a non-transitory computer readable medium has instructions stored thereon, where the instructions, when executed by at least one processor, cause a device to perform operations that include obtaining data identifying a plurality of containers to hold items for an order. The operations may further include assigning a first number of the plurality of containers to a first section of a storage rack of a delivery vehicle, and determining whether the first section of the storage rack of the delivery vehicle can store at least one additional container. The operations may also include assigning a second number of the plurality of containers to a second section of the storage rack of the delivery vehicle based on determining that the first section of the storage rack cannot store the at least one additional container. The operations may include assigning a third number of the plurality of containers to a third section of the storage rack of the delivery vehicle, and storing data identifying the assignments of the first number, second number, and third number of the plurality of containers. In some examples, the operations may include transmitting the assignments to another computing device.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a delivery management system in accordance with some embodiments;

FIG. 2 is a block diagram of the delivery management computing device of FIG. 1 in accordance with some embodiments;

FIG. 3A illustrates an example of a delivery vehicle in accordance with some embodiments;

FIG. 3B illustrates an example cargo area of the delivery vehicle of FIG. 3A in accordance with some embodiments;

FIG. 3C illustrates another example cargo area of the delivery vehicle of FIG. 3A in accordance with some embodiments;

FIG. 3D illustrates yet another example cargo area of the delivery vehicle of FIG. 3A in accordance with some embodiments;

FIG. 4A is a block diagram a container labelling system in accordance with some embodiments;

FIG. 4B illustrates a container with a label generated by the container labelling system of FIG. 4A in accordance with some embodiments;

FIG. 5A illustrates an example of a transport system for transporting containers in accordance with some embodiments;

FIG. 5B illustrates another example of a transport system for transporting containers in accordance with some embodiments;

FIG. 5C illustrates yet another example of a transport system for transporting containers in accordance with some embodiments;

FIG. 6 is a block diagram illustrating examples of various portions of the delivery management system of FIG. 1 in accordance with some embodiments;

FIG. 7 is a flowchart of an example method that can be carried out by the delivery management computing device of FIG. 1 in accordance with some embodiments; and

FIG. 8 is a flowchart of another example method that can be carried out by the delivery management computing device of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

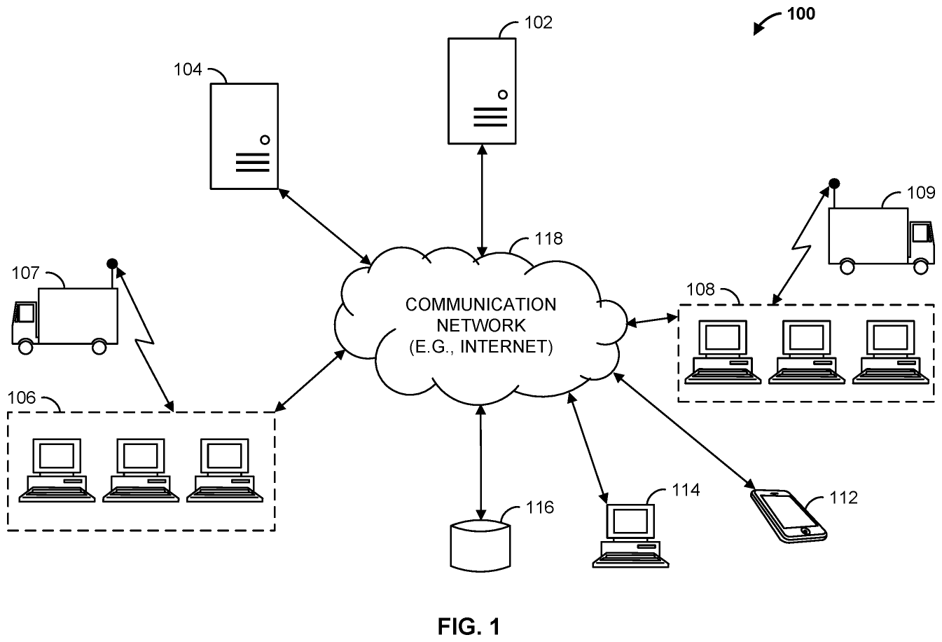

Turning to the drawings, FIG. 1 illustrates a block diagram of a delivery management system 100 that includes a delivery management computing device 102 (e.g., a server, such as an application server), a web hosting device 104 (e.g., a web server), workstation(s) 106, workstation(s) 108, database 116, and multiple customer computing devices 112, 114 operatively coupled over network 118. Delivery management computing device 102, web hosting device 104, workstation(s) 106, workstation(s) 108, and multiple customer computing devices 112, 114 can each be any suitable computing device that includes any hardware or hardware and software combination for processing and handling information. In addition, each can transmit data to, and receive data from, communication network 118.

For example, each of delivery management computing device 102, web hosting device 104, workstation(s) 106, workstation(s) 108, and multiple customer computing devices 112, 114 can be a computer, a workstation, a laptop, a mobile device such as a cellular phone, a web server, an application server, a cloud-based server, or any other suitable device. Each can include, for example, one or more processors, one or more field-programmable gate arrays (FPGAs), one or more application-specific integrated circuits (ASICs), one or more state machines, digital circuitry, or any other suitable circuitry.

Although FIG. 1 illustrates two customer computing devices 112, 114, delivery management system 100 can include any number of customer computing devices 112, 114. Similarly, delivery management system 100 can include any number of workstation(s) 106, 108, delivery management computing devices 102, web hosting devices 104, and databases 116.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

Delivery management computing device 102, web hosting device 104, and workstation(s) 106, 108 may be operated by a retailer. Customer computing devices 112, 114 may be computing devices operated by customers of a retailer. For example, web hosting device 104 may host one or more web pages for the retailer. Each customer computing device 112, 114 may be operable to access the one or more webpages hosted by web hosting device 104 over communication network 118. For example, a customer operating a customer computing device 112, 114 may view a retailer's website hosted by web hosting device 104 as displayed by the customer computing device 112, 114, and may purchase products, such as goods or services, from the retailer's website by interacting with the website via the customer computing device 112, 114.

Workstation(s) 106, 108 may be operably coupled to communication network 118 via a router (or switch). As such, workstation(s) 106, 108 can communicate with delivery management computing device 102 over communication network 118. For example, workstations(s) 106, 108 may transmit data, such as purchase order data, to delivery management computing device 102. Similarly, workstation(s) 106, 108 may receive data, such as vehicle loading data described below, from delivery management computing device 102. Workstation(s) 106, 108 may be located at a retail location, such as a store. For example, workstation(s) 106 may be located on one store location for a retailer, and workstation(s) 108 may be located at another store location for that same, or different, retailer. In some examples, workstation(s) 106, 108 may be located at a warehouse storing purchased goods, anywhere purchased goods may be located, or anywhere where purchased goods may be loaded onto a delivery vehicle, for example.

In some examples, a delivery vehicle, such as a truck, may be communicatively coupled to workstation(s) 106, 108. For example, delivery vehicle 107 may be communicatively coupled to workstation(s) 106, and delivery vehicle 109 may be operatively coupled to workstation(s) 108. In some examples, each delivery vehicle 107, 109 may communicate with a corresponding workstation(s) 106, 108 via a cellular network, a WiFi® network, or any other suitable network. In some examples, delivery vehicles 107, 109 are communicatively coupled to network 118. In some examples, delivery vehicles 107, 109 drive to a retailer's location to load purchased goods for delivery. For example, workstation(s) 106 may be located in a delivery room (e.g., “back room”) of a retailer's location where purchased goods, store din containers, may be loaded onto delivery vehicle 107. Similarly, workstation(s) 108 may be located in a delivery room (e.g., “back room”) of a different retailer's location where purchased goods, store din containers, may be loaded onto delivery vehicle 109. Each of the delivery vehicles 107, 109 may be loaded with purchased goods, and may depart from the retailer's location to deliver the purchased goods at one or more delivery addresses.

Delivery management computing device 102 is operable to communicate with database 116 over communication network 118. For example, delivery management computing device 102 can store data to, and read data from, database 116. Database 116 may be a tangible, non-transitory memory. For example, database 116 may be a remote storage device, such as a cloud-based server, a memory device on another application server, a networked computer, or any other suitable remote storage. Although shown remote to delivery management computing device 102, in some examples, database 116 can be a local storage device, such as a hard drive, a non-volatile memory, or a USB stick. Database 116 may store purchase order data. For example, a customer may purchase good from a retailer's website hosted by web hosting device 104. Web hosting device 104 may store purchase order data identifying and characterizing the order in database 116. Delivery management computing device 102 may then obtain the purchase order data from database 116.

Delivery management computing device 102 may determine container assignments for containers holding goods to be loaded onto a delivery vehicle. These determinations may be based on a number of containers required for each purchase order. The container assignments may include one or more of a load number (e.g., delivery vehicle identifier or ID), an order ID, and a rack section and rack position of a racking system of the delivery vehicle 107, 109. The container assignments may be printed on labels that are then attached to the containers. In some examples, delivery management computing device 102 determines a row and column position of a rack system of a delivery vehicle 107, 109 for each container. The row and column position may identify a compartment of the rack system. The row and column information may be printed on the label that is attached to each container. An associate of a retailer, for example, may then proceed to load a storage rack of a delivery vehicle 107, 109 in accordance with the label information.

In some examples, delivery management computing device 102 transmits the container assignments to another computing device, such as a mobile device. An associate operating the other computing device may then proceed to load a storage rack of a delivery vehicle 107, 109 in accordance with the container assignments. For example, the labels on the containers may include a container ID. The associate operating the other computing device may identify the assignment for the container based on the container ID and the received container assignments. For example, the associate may match the container ID on the label attached to the container to a container ID received in the container assignments.

In some examples, the containers are marshaled by a corresponding load number and additionally segregated by their “front/middle/back” rack position (e.g., as indicated on the labels) of the racking system of the delivery vehicle. This system may allow the containers to more efficiently be loaded, in this example, three deep onto racks of the delivery vehicle 107, 109. For example, “back” containers would be loaded onto a “back” rack of a rack system of the delivery vehicle 107, 109. “Middle” containers would be loaded onto a “middle” rack of the rack system of the delivery vehicle 107, 109, and “front” containers would be loaded onto a “front” rack of the rack system of the delivery vehicle 107, 109.

In some examples, delivery management computing device 102 assigns containers for a same delivery address to be stored at a same row-column position in the rack system, but at different “front/middle/back” rack positions. For example, a first container holding goods to be delivered at a particular location may be placed in a “back” rack position, a second container holding goods to be delivered the same location may be placed in a “middle” rack position, and a third container holding goods to be delivered at the same location may be placed in a “last” rack position. In some examples, delivery management computing device 102 assigns containers for a same delivery address to be stored at a same “front/middle/back” rack position, such as in side by side compartments of a same rack position.

In some examples, “back” containers are loaded onto one or more transportation devices, such as a dolly or trolley, identified for “back” containers. The transportation devices holding “back” containers may then be wheeled to a loading dock, such as a loading dock where the containers may be loaded onto delivery vehicle 107, 109. Similarly, “middle” containers are loaded onto one or more transportation devices identified for “middle” containers, and “front” containers are loaded onto one or more transportation devices identified for “front” containers. The transportation devices holding “middle” and “front” containers may also be wheeled to the loading dock. The transportation devices may be arranged at the loading dock such that containers from the “back” transportation devices may be removed for loading first into the delivery vehicle 107, 109. The transportation devices may be further arranged such that containers from the “middle” transportation devices may be removed for loading next into the delivery vehicle 107, 109, and containers from the “front” transportation device may be removed for loading into the delivery vehicle 107, 109 after the “middle” containers have been loaded.

With this system, one or more advantages may be realized. For example, an associate would not spend much time in locating a next container to load onto a delivery vehicle 107, 109, as the containers marshaled by “front/middle/back” and, in some examples, having row & column positions printed on a label, removes much of the physical effort of sorting the containers by sequence numbers. In addition, the amount of time to load delivery vehicles may be reduced. Moreover, the amount of time to unload containers for delivery, once the delivery vehicle arrives at a delivery location, may be reduced. For example, delivery personnel may more easily identify and unload the containers for delivery without having to first remove containers meant for another delivery location. Persons of ordinary skill in the art would recognize additional advantages as well.

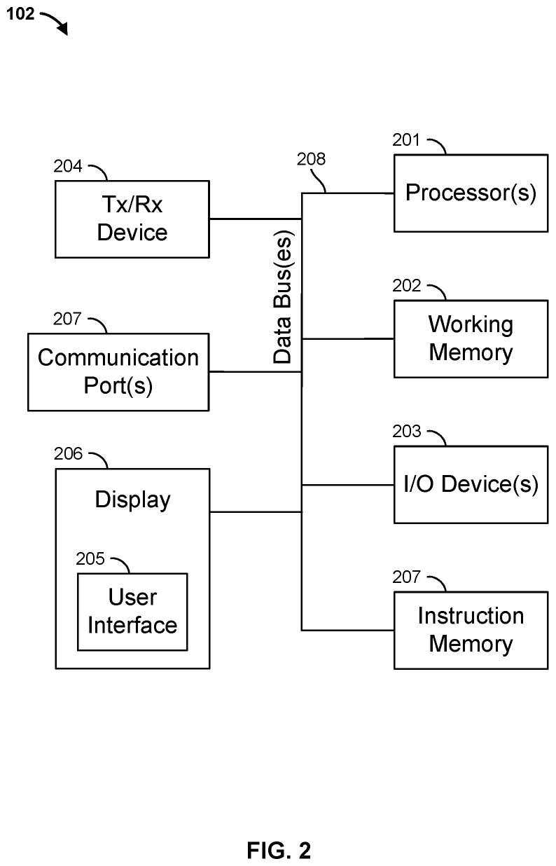

FIG. 2 illustrates the delivery management computing device 102 of FIG. 1. Delivery management computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of delivery management computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 207 can include, for example, a serial port such as a universal asynchronous receiver/transmitter (UART) connection, a Universal Serial Bus (USB) connection, or any other suitable communication port or connection. In some examples, communication port(s) 207 allows for the programming of executable instructions in instruction memory 207. In some examples, communication port(s) 207 allow for the transfer (e.g., uploading or downloading) of data, such as container assignment data.

Display 206 can display user interface 205. User interfaces 205 can enable user interaction with delivery management computing device 102. For example, user interface 205 can be a user interface for an application that allows for the viewing of semantic representations of user queries. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 delivery management computing device 102 will be operating in. Processor(s) 201 is operable to receive data from, or send data to, a network, such as communication network 118 of FIG. 1, via transceiver 204.

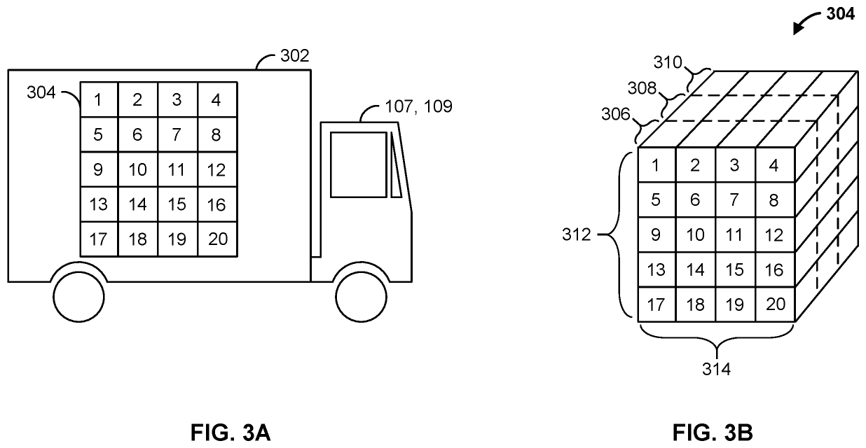

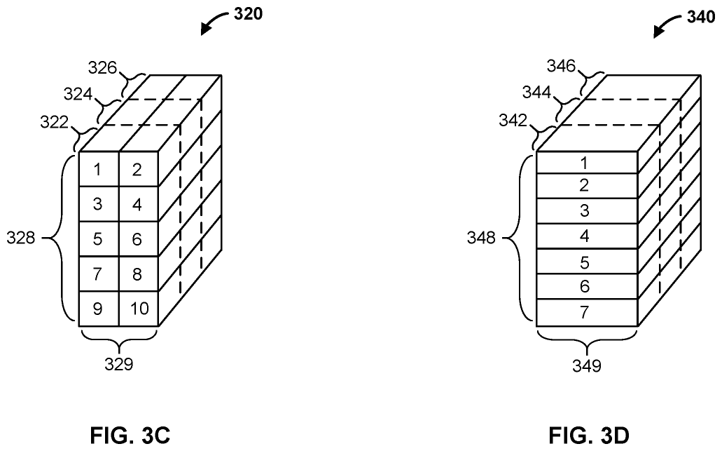

FIGS. 3A and 3B illustrate an example of the delivery truck 107, 109 of FIG. 1. As illustrated, delivery truck 107, 109 includes a cargo area 302. The cargo area 302 includes a storage rack 304 with various compartments in a configuration of five rows 312 and four columns 314 where each compartment is identified, in this example, as compartments 1 through 20. For example, compartment 1 may be located at a first row, first column of storage rack 304, while compartment 20 may be located at the fifth row, fourth column of storage rack 304.

Each compartment may include a number of holding areas. In this example, each compartment includes a “front” holding area 306, a “middle” holding area 308, and a “back” holding area 310 for a total of three holding areas per compartment. In some examples, storage rack 304 may include multiple storage areas. The various storage areas may be temperature controlled at varying temperatures. For example, storage rack 304 may include an “Ambient” storage section for storing goods that may be kept at ambient temperatures, such as canned goods, bread, or cereal, for example. Storage rack 304 may also include a “Chilled” storage section for storing goods that should be kept at cooler temperatures, such as milk, juice, or yogurt, for example. In some examples, storage rack may include a “Frozen” storage section for storing goods that should be kept frozen such as meat or ice cream.

In some examples, containers with goods that are typically stored in one storage rack may be stored instead in a different storage rack. For example, delivery management computing device 102 may assign a container that is holding goods that can be stored in an Ambient storage rack in a “Chilled” storage rack. As an example, delivery management computing device 102 may determine all compartments in the Ambient storage rack are full, although room remains in the “Chilled” storage rack. In this case, delivery management computing device 102 may assign the container to a compartment in the “Chilled” storage rack. This accommodation allows containers that otherwise would exceed the storage capacity of one storage rack to still be store on the vehicle for delivery.

Storage rack 304 may also include different compartment configurations. For example, FIG. 3C illustrates a storage rack 320 in a configuration of five rows 328 and two columns 329 with compartments identified as compartments 1 through 10. For example, compartment 1 may be located at a first row, first column of storage rack 320, while compartment 10 may be located at the fifth row, second column of storage rack 320. Each compartment may include a “front” holding area 322, a “middle” holding area 324, and a “back” holding area 326. Storage rack 320 may be, for example, a “Chilled” storage rack where items that need to be stored at cooler temperatures can be stored.

FIG. 3D illustrates a storage rack 340 in a configuration of seven rows 348 and one column 349 with compartments identified as compartments 1 through 7. For example, compartment 1 may be located at a first row, first column of storage rack 340, while compartment 7 may be located at the seventh row, first column of storage rack 340. Each compartment may include a “front” holding area 342, a “middle” holding area 344, and a “back” holding area 346. Storage rack 340 may be, for example, a “Frozen” storage rack where items that need to be stored at colder temperatures can be stored.

In some examples, an associate, such as one operating workstation(s) 106, 108, provide the storage rack configuration for the storage racks for delivery vehicles to be used for deliveries. Workstation(s) 106, 108 may store the configurations in, for example, database 116. Delivery management computing device 102 may obtain the configuration data from database 116 to determine storage rack configurations for the assignment of containers to storage racks, as described below.

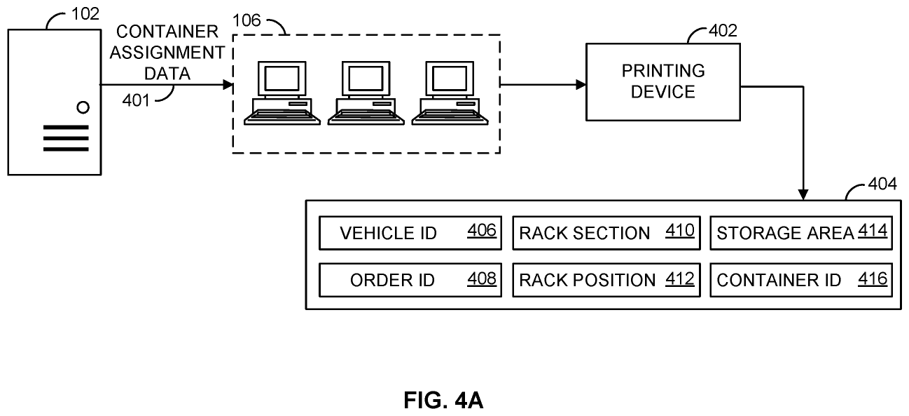

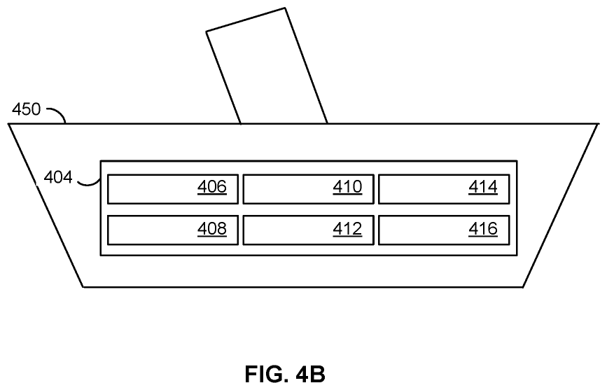

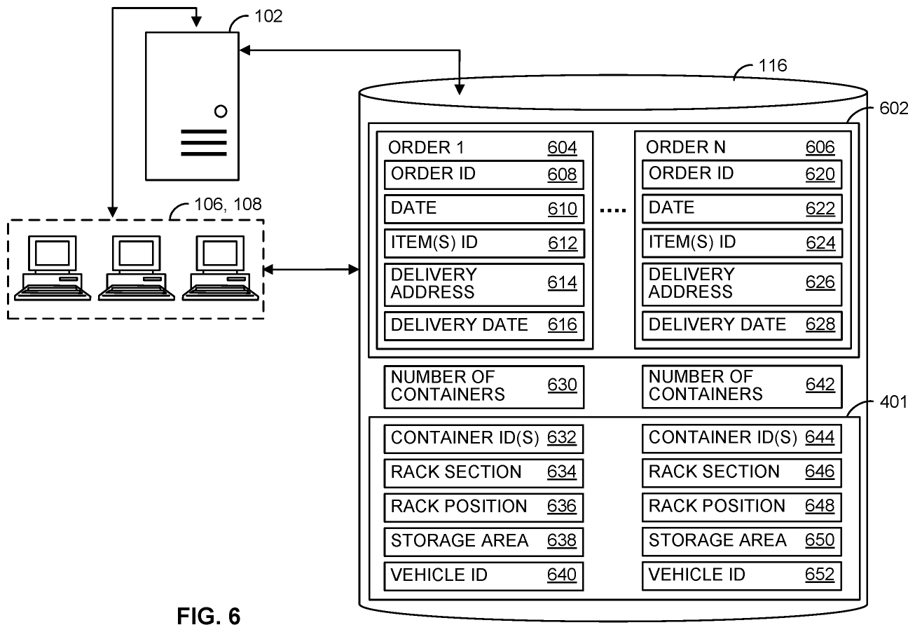

FIG. 4A illustrates a container labelling system 400 that includes delivery management computing device 102, workstation(s) 106, and a printing device 402. Printing device 402 may be a printer, a label maker, a labelling machine, or any other suitable printing device. Based on order information (e.g., as discussed in more detail with respect to FIG. 6 below), delivery management computing device 102 may determine container assignments for a storage rack 304, 324, 340 of a delivery vehicle 107, 109. For example, delivery management computing device 102 may assign a plurality of containers, such as container 450 illustrated in FIG. 4B, to one or more delivery vehicles 107, 109, and generate container assignment data 401 that is transmitted to workstation(s) 106.

The container assignment data 401 may include data identifying a vehicle for delivery (e.g., a vehicle ID), data identifying an order for the container (e.g., an order ID identifying the order number associated with the goods in the container), data identifying a rack section (e.g., 306, 308, 310) of the storage rack 304, 324, 340 of the delivery vehicle 107, 109, and data identifying a rack position of the storage rack 304, 324, 340 of the delivery vehicle 107, 109. In some examples, the rack section data identifies a “front,” “middle,” or “back” section of the storage rack, and the rack position data identifies a row and column of the storage rack. In some examples, container assignment data 401 may also include data identifying a storage area of a storage rack, such as an “Ambient” storage area, a “Chilled” storage area, and a “Frozen” storage area.

Workstation(s) 106 may receive the container assignment data 401, and format the container assignment data 401 to provide all or a portion of it to printing device 402. Workstation(s) 106 may then transmit the formatted data to printing device 402 for the printing of one or more labels. For example, workstation(s) 106 may send a “print” command to printing device 402, along with data identifying the container data to print. Upon receiving the data, printing device 402 may print a label 404. Label 404 may include, for example, one or more of a vehicle ID 406, an order ID 408, a rack section 410, a rack position 412, and a storage area 414. Label 404 may then be placed on a container, such as container 450. An associate (e.g., a picker) may then fill the container with goods corresponding to the order identified by the label 404. For example, for a given order, the associate may place goods associated with that order in containers labelled with a corresponding order ID 408.

In some examples, the associate places goods in various containers for the same order based on a storage area of a storage rack the containers should be placed in. For example, the associate may place goods that may be stored in an ambient temperate in a container labelled with a storage area 414 of “Ambient.” Similarly, the associate may place good that should be stored in cooler temperatures in a container labeled with a storage area 414 of “Chilled,” and may place goods that should be stored in colder temperatures in a container labelled with a storage area 414 of “Frozen.”

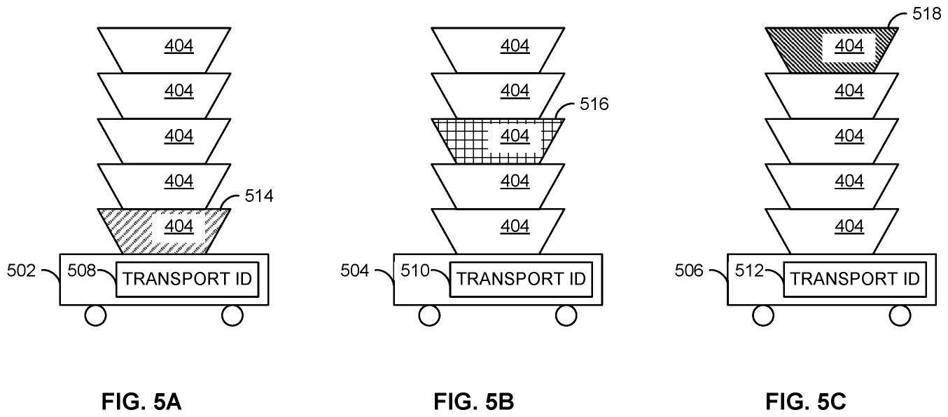

FIGS. 5A, 5B, and 5C illustrate transport systems 502, 504, 506 for transporting containers. Each transport system 502, 504, 506 may be a dolly, for example. Each transport system 502, 504, 506 may be labeled or otherwise marked with a transport identification (ID). For example, as illustrated, transport system 502 includes a transport ID 508. Likewise, transport system 504 includes transport ID 510, and transport system 506 includes transport ID 512. Each transport ID 508, 510, 512 may identify a rack section of a storage rack of a delivery vehicle, such as storage rack 304 of delivery vehicle 107, 109. For example, the transport ID 504 may identify a “front,” “back,” or “middle” rack section of the storage rack. After containers are filled with corresponding goods, an associate may place the containers on corresponding transport system for transport to, for example, a loading area for a delivery vehicle.

For example, transport system 502 may be labelled with a transport ID 508 of “front.” Similarly, transport system 504 may be labelled with a transport ID 510 of “middle,” and transport system 506 may be labelled with a transport ID 512 of “back.” An associate may place containers labelled with a rack section 410 of “front” on transport system 502, which is labelled with a transport ID 508 of “front.” Similarly, an associate may place containers labelled with a rack section 410 of “middle” on transport system 504, which is labelled with a transport ID 510 of “middle.” The associate may place containers labelled with a rack section 410 of “back” on transport system 506, which is labelled with a transport ID 512 of “back.” In other words, the associate may place containers labelled with a particular rack section 410 onto transport systems 502, 504, 506 with corresponding transport IDs 508, 510, 512.

FIG. 6 illustrates portions of the delivery management system 100 of FIG. 1 including the delivery management computing device 102, workstation(s) 106, 108, and database 116. As noted above, delivery management computing device 102 may determine container assignment data 401 for containers 406 that may be stored in a storage rack 304, 324, 340 of a delivery vehicle 107, 109. Delivery management computing device 102 may store the generated container assignment data 401 in database 116. To determine the container assignment data 401, delivery management computing device 102 may obtain order data 602 from database 116. Order data 602 may include order information, such as purchase order information (e.g., purchase order data), for one or more orders to be delivered. Order data 602 may be stored in database 116 by web hosting device 104, for example.

Order data 602 may include data identifying a plurality of orders, such as orders placed on a retailer's website. As illustrated, order data 602 may include first order data 604 up to N^{th} order data 606. First order data 604 may include an order ID 608, which may identify the order. First order data 605 may also include a date 610, which may be the date the order was placed, and one or more item IDs 612, where each item ID 612 identifies an ordered item. First order data 605 may also include a delivery address 614 identifying the delivery address for first order data 604, and a delivery date 616 identifying the date of delivery for first order data 604. Similarly, N^{th} order data 606 may include one or more of order ID 620, date 622, item(s) ID 624, delivery address 626, and delivery date 628.

Database 116 may also store data identifying a number of containers used for each order, and a container ID for each container. For example, first order data 604 may require a number of containers 630 where each container is identified by a container ID 632. Similarly, N^{th} order data 606 may require a number of containers 642 identified by container ID(s) 644. In some examples, an associate, operating for example workstation(s) 106, 108, provides the number of containers 630, 642 that are holding the items purchased for each order, as well as the container IDs 632, 644 identifying the containers used for each order, to workstation(s) 106, 108, and workstation(s) 106, 108 may store the data in database 116. In some examples, the number of containers and container IDs are computed based on each order, and stored in database 116.

For each order identified by order data 602, delivery management computing device 102 may determine a rack section and rack position of a storage rack 304 for a delivery vehicle 107, 109. For example, and referring to first order data 604, delivery management computing device 102 my assign a first container of the number of containers 630 identified by a container ID 632 to a “back” rack section of the storage rack 304. Delivery management computing device 102 may also assign the first container to a rack position (e.g., compartment) identified by a last row, and first column, of the storage rack 304. Delivery management computing device 102 may assign a second container of the number of containers to a “middle” rack section of the storage rack, and to the same rack position (i.e., last row, first column), of the storage rack 304. Delivery management computing device 102 may also assign a third container of the number of containers to a “front” rack section of the storage rack, and to the same rack position. Assuming the storage rack has three sections, the three containers are assigned to a same compartment with one in each section of the compartment.

In some examples, delivery management computing device 102 may continue assigning containers identified by either first order data 104 or a next order, such as Nth order data 606, by assigning the containers to the storage rack 304 from a last row, first column compartment, to a first row, last column compartment (e.g., from a “bottom-left” compartment to a “top-right” compartment), from the “back” of the storage rack 304 to the “front” of the storage rack 304. For example, delivery management computing device 102 may continue assigning any remaining containers identified by first order data 604 to the last row, second column, of the storage rack, again beginning with the “back” section.

In some examples, delivery management computing device 102 assigns containers to fill a rack section, such as a “back,” “middle,” or “front” section, of a storage rack 304 before proceeding with assigning containers to a different rack section. For example, and referring to first order data 604, delivery management computing device 102 my assign a first container of the number of containers 630 identified by a container ID 632 to a “back” rack section of the storage rack 304. Delivery management computing device 102 may also assign the first container to a rack position (e.g., compartment) identified by a last row, and first column, of the storage rack 304. Delivery management computing device 102 may assign a second container of the number of containers to the same “back” rack section of the storage rack, but to a different rack position, such as the last row, second column, of the storage rack 304. Delivery management computing device 102 may also assign a third container of the number of containers to the same “back” rack section of the storage rack, and to a different rack position, such as the last row, third column, of the storage rack 304. Assuming the storage rack has three sections, the three containers are assigned to three different compartments, but to the same rack section.

In some examples, delivery management computing device 102 may continue assigning containers identified by either first order data 104 or a next order, such as Nth order data 606, by assigning the containers to the same section of the storage rack 304 from a last row, first column compartment, to a first row, last column compartment (e.g., from a “bottom-left” compartment to a “top-right” compartment). Once containers have been assigned to the rack section for all compartments, delivery management computing device 102 may begin assigning containers to a different section, such as a “middle” rack section of the storage rack 304. Similarly, once the “middle” rack section has been assigned containers for all compartments, delivery management computing device 102 may begin assigning containers to another section, such as a “front” rack section of the storage rack 304.

For each container, delivery management computing device 102 may store, in database 116, the determined rack section and rack position of the storage rack. For example, delivery management computing device 102 may store a determined rack section 634 and rack position 636 for a container identified by container ID 632 for first order 604 in database 116. Similarly, delivery management computing device 102 may store a determined rack section 646 and rack position 648 for a container identified by container ID 632 for first order 604 in database 116.

In some examples, the associate may also provide a storage area 638, 650 for each container, which may be stored in database 116. The storage area 638, 650 identifies a storage area (e.g., “Ambient,” “Chilled,” “Frozen”) of a storage rack 304 that the corresponding container should be placed in for deliver. In some examples, the associate may provide a vehicle ID 640, 652 identifying the delivery vehicle for a particular container. In some examples, all containers associated with a same order are associated with a same vehicle ID 640, 652. In some examples, all containers for all orders being delivered to a same delivery address 614, 626 are associated with a same vehicle ID 640, 652. The associate, operating workstation(s) 106, 108, may cause workstation(s) 106, 108 to store storage areas 638, 650 and vehicle IDs 640, 652 in database 116.

One or more of the rack section 634, 646, rack position 636, 648, storage area 638, 650, container ID 632, 649, order ID 608, 620, or vehicle ID 640, 652 associated with each container may be printed on a label 404 and attached to a corresponding container 450, as described above with respect to FIGS. 4A, 4B.

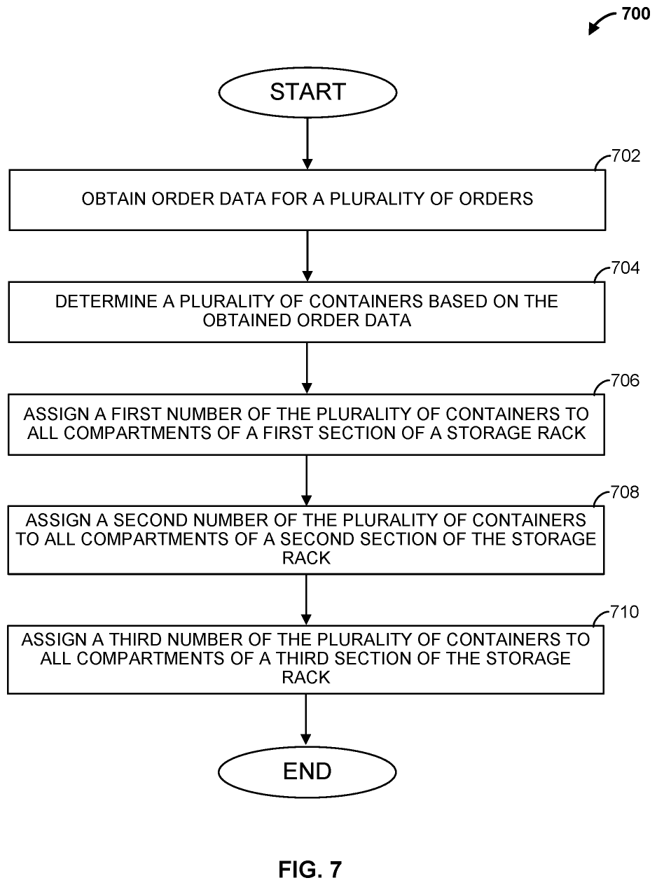

FIG. 7 is a flowchart of an example method 700 that can be carried out by, for example, the delivery management computing device 102 of FIG. 1. Beginning at step 702, order data, such as order data 602, is obtained for a plurality of orders. At step 704, a plurality of containers are determined based on the obtained order data. For example, delivery management computing device 102 may determine a number of containers 630 for first order data 604, and a number of containers 642 for N^{th} order data 606. Proceeding to step 706, a first number of the plurality of containers are assigned to all compartments of a first section of a storage rack. For example, delivery management computing device 102 may assign the containers to a “back” section of compartments of a storage rack 304 until the back section can no longer accommodate containers.

The containers may be assigned starting from a compartment located at first row and first column of the storage rack, and proceed along the first row until all compartments for that row have been assigned a container. The containers may then be assigned starting from a second row and first column of the storage rack, and again proceed along the second row until all compartments for that row have been assigned a container. The containers may be assigned to compartments at other row and columns of the storage rack in a similar fashion.

The method then proceeds to step 708, where a second number of the plurality of containers are assigned to all compartments of a second section of a storage rack. For example, delivery management computing device 102 may assign the containers to a “middle” section of the compartments of the storage rack 304 until the middle section can no longer accommodate containers. Proceeding to step 710, a third number of the plurality of containers are assigned to all compartments of a third section of a storage rack. For example, delivery management computing device 102 may assign the containers to a “front” section of the compartments of the storage rack 304 until the front section can no longer accommodate containers. The method then ends.

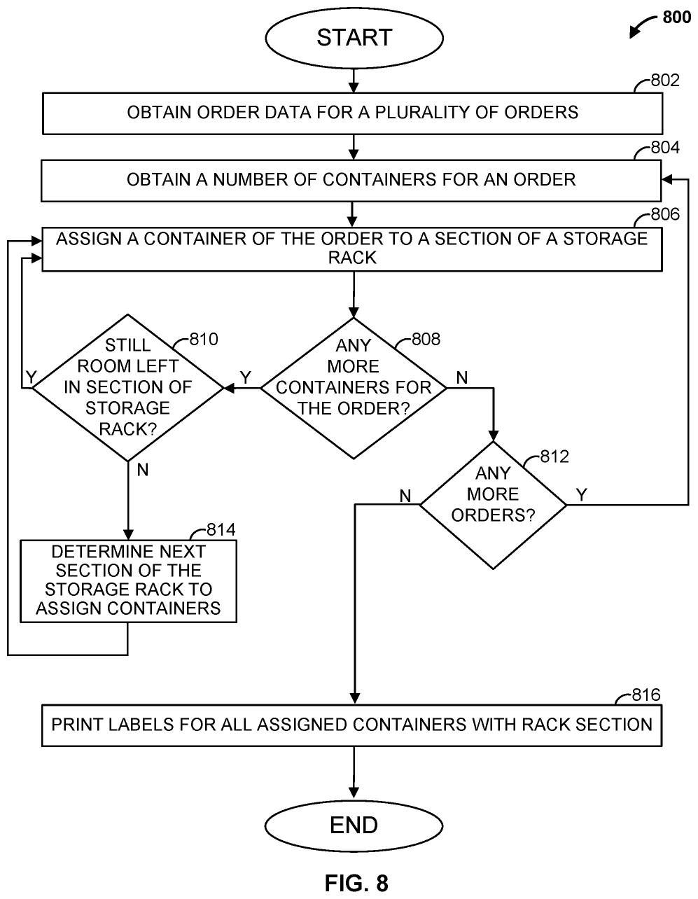

FIG. 8 is a flowchart of another example method 800 that can be carried out by, for example, the delivery management computing device 102 of FIG. 1. Beginning at step 802, order data, such as order data 602, is obtained for a plurality of orders. At step 804, a number of containers for an order is obtained. For example, delivery management computing device 102 may determine a number of containers 630 for a first order 604 identified by obtained order data 602. Proceeding to step 806, a container of the number of containers for the order is assigned to a section of a storage rack. For example, delivery management computing device 102 may assign a container of the order to a “back” section of the storage rack.

At step 808, a determination is made as to whether there are any more containers for the order. For example, delivery management computing device 102 may determine whether there are any more containers for the order based on a number of containers 630. If there is any container for the order yet to be assigned, the method proceeds to step 810; otherwise, if there are no more containers for the order to be assigned, the method proceeds to step 812.

At step 810, a determination is made as to whether there is room left for an additional container to be assigned to the section of the storage rack. For example, delivery management computing device 102 may determine if there are any compartments in the section of the storage rack that have not yet been assigned a container. If there is still room available in that section of the storage rack for an additional container, the method proceeds back to step 806, where another container is assigned to the section of the storage rack (e.g., to a compartment with available storage in that section of the storage rack). Otherwise, if there the section cannot be assigned any more containers, the method proceeds to step 814. At step 814, a next section of the storage rack is determined for container assignments. For example, delivery management computing device 102 may determine that the “middle” section of the storage rack will be assigned containers next. The method then proceeds back to step 806, where a container of the order is assigned to the determined next section of the storage rack.

Back at step 812, a determination is made as to whether there are any more orders. For example, based on order data 602, delivery management computing device 102 may determine if there are any more orders, such as N^{th} order data 604. If there are more orders, the method proceeds back to step 804, where a number of containers for the next order is obtained. Otherwise, if there are no more orders, the method proceeds to step 816.

At step 816, labels for all assigned containers are printed. The labels may include the rack section for each container. The method then ends.

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device configured to:
obtain data identifying a plurality of containers to hold items for an order;
assign a first number of the plurality of containers to a first section of a storage rack of a delivery vehicle;
determine whether the first section of the storage rack of the delivery vehicle can store at least one additional container;
based on determining that the first section of the storage rack cannot store the at least one additional container, assign a second number of the plurality of containers to a second section of the storage rack of the delivery vehicle; and
store data identifying the assignments of the plurality of containers.

2. The system of claim 1, wherein the computing device is configured to:
determine whether the second section of the storage rack of the delivery vehicle can store at least one additional container; and
assign a third number of the plurality of containers to the third section of the storage rack of the delivery vehicle based on determining that the second section of the storage rack cannot store the at least one additional container.

3. The system of claim 2, wherein the first section of the storage rack is a back section, the second section of the storage rack is a middle section, and the third section of the storage rack is a front section.

4. The system of claim 1, wherein assigning the first number of the plurality of containers to the first section of the storage rack of the delivery vehicle comprises:
determining a row of the first section;
determining a column of the first section; and
assigning the first number of the plurality of containers to a compartment at the determined row and column of the first section.

5. The system of claim 1, wherein assigning the first number of the plurality of containers to the first section of the storage rack of the delivery vehicle comprises assigning containers to compartments of the storage rack beginning with a first compartment located at a first row, and first column, of the first section, and ending with a last compartment located at a last row, and last column, of the first section.

6. The system of claim 5, wherein assigning the second number of the plurality of containers to the second section of the storage rack of the delivery vehicle comprises assigning containers to the compartments of the storage rack beginning with the first compartment located at the first row, and first column, of the second section, and ending with the last compartment located at the last row, and the last column, of the second section.

7. The system of claim 1 wherein the computing device is configured to generate labels for a transport system, wherein the labels identify either the first section or second section of the storage rack of the delivery vehicle.

8. The system of claim 1 wherein the computing device is configured to transmit to a mobile device the data identifying the assignments of the plurality of containers.

9. A method comprising:
obtaining data identifying a plurality of containers to hold items for an order;
assigning a first number of the plurality of containers to a first section of a storage rack of a delivery vehicle;
determining whether the first section of the storage rack of the delivery vehicle can store at least one additional container;
based on determining that the first section of the storage rack cannot store the at least one additional container, assigning a second number of the plurality of containers to a second section of the storage rack of the delivery vehicle; and
storing data identifying the assignments of the plurality of containers.

10. The method of claim 9 further comprising:
determining whether the second section of the storage rack of the delivery vehicle can store at least one additional container; and
assigning a third number of the plurality of containers to a third section of the storage rack of the delivery vehicle based on determining that the second section of the storage rack cannot store the at least one additional container.

11. The method of claim 10 wherein the first section of the storage rack is a back section, the second section of the storage rack is a middle section, and the third section of the storage rack is a front section.

12. The method of claim 9 wherein assigning the first number of the plurality of containers to the first section of the storage rack of the delivery vehicle comprises:
determining a row of the first section;
determining a column of the first section; and
assigning the first number of the plurality of containers to a compartment at the determined row and column of the first section.

13. The method of claim 9 wherein assigning the first number of the plurality of containers to the first section of the storage rack of the delivery vehicle comprises assigning containers to compartments of the storage rack beginning with a first compartment located at a first row, and first column, of the first section, and ending with a last compartment located at a last row, and last column, of the first section.

14. The method of claim 13 wherein assigning the second number of the plurality of containers to the second section of the storage rack of the delivery vehicle comprises assigning containers to the compartments of the storage rack beginning with the first compartment located at the first row, and first column, of the second section, and ending with the last compartment located at the last row, and the last column, of the second section.

15. The method of claim 9 further comprising generating labels for a transport system, wherein the labels identify either the first section or second section of the storage rack of the delivery vehicle.

16. The method of claim 9 further comprising transmitting to a mobile device the data identifying the assignments of the plurality of containers.

17. A non-transitory computer readable medium having instructions stored thereon, wherein the instructions, when executed by at least one processor, cause a device to perform operations comprising:
obtaining data identifying a plurality of containers to hold items for an order;
assigning a first number of the plurality of containers to a first section of a storage rack of a delivery vehicle;
determining whether the first section of the storage rack of the delivery vehicle can store at least one additional container;
based on determining that the first section of the storage rack cannot store the at least one additional container, assigning a second number of the plurality of containers to a second section of the storage rack of the delivery vehicle; and
storing data identifying the assignments of the plurality of containers.

18. The non-transitory computer readable medium of claim 17 further comprising instructions stored thereon that, when executed by at least one processor, further cause the device to perform operations comprising:
determining whether the second section of the storage rack of the delivery vehicle can store at least one additional container; and
assigning a third number of the plurality of containers to a third section of the storage rack of the delivery vehicle based on determining that the second section of the storage rack cannot store the at least one additional container.

19. The non-transitory computer readable medium of claim 16 further comprising instructions stored thereon that, when executed by at least one processor, further cause the device to perform operations comprising:
determining a row of the first section;
determining a column of the first section; and
assigning the first number of the plurality of containers to a compartment at the determined row and column of the first section.

20. The non-transitory computer readable medium of claim 16 further comprising instructions stored thereon that, when executed by at least one processor, further cause the device to perform operations comprising:
assigning containers to compartments of the storage rack beginning with a first compartment located at a first row, and first column, of the first section, and ending with a last compartment located at a last row, and last column, of the first section.
